(19) United States
(12) Patent Application Publication
(10) Pub. No.: US 2026/0336416 A1
(43) Pub. Date: Oct. 29, 2026

(54) Holding Arrangement of an Instrument Panel on a Support for a Motor Vehicle and Motor Vehicle

(71) Applicant: Bayerische Motoren Werke Aktiengesellschaft, Muenchen (DE)

(72) Inventors: Siegfried FURKERT, Muenchen (DE); Alexander ROSEMANN, Muenchen (DE)

(21) Appl. No.: 19/485,315

(22) PCT Filed: May 2, 2024
(86) PCT No.: PCT/DE2024/100393

§ 371 Date: Nov. 18, 2025

(30) Foreign Application Priority Data
May 26, 2023 (DE) 10 2023 113 889.8

(51) Int. Cl. B60K 37/10; B60R 21/045

(52) U.S. Cl. CPC B60K 37/10; B60R 21/045; B60K 2360/652

(57) ABSTRACT

A holding arrangement of an instrument panel is provided on a support for a cockpit of a motor vehicle, in which cockpit the instrument panel, formed separately from the support, is held on the support. A load distribution element that can be deformed by an accident-related application of force is arranged between at least a first partial region of the instrument panel and at least a second partial region of the support.

### BACKGROUND AND SUMMARY

The invention relates to a holding arrangement for holding an instrument panel on a support for a motor vehicle. Further, the invention relates to a motor vehicle, in particular a passenger car.

WO 2004/067334 A1 discloses an interior trim part for a motor vehicle, having a plastics support. US 9 927 642 B2 discloses a display unit for a vehicle. Moreover, DE 10 2006 008 564 B4 discloses an airbag guide having a cover.

The present invention addresses the problem of creating a holding arrangement for holding an instrument panel on a support for a motor vehicle, and a motor vehicle having such a holding arrangement, such that particularly advantageous behavior in the event of an accident can be realized.

This problem is solved according to the invention by a holding arrangement and by a motor vehicle having the features of the independent claims. Advantageous refinements of the invention are the subject matter of the dependent claims.

A first aspect of the invention relates to a holding arrangement for holding an instrument panel, also referred to as an I-panel, on a support, also referred to as a base support or equipment support or cockpit support, for a cockpit of a motor vehicle. This means that the motor vehicle, which is also referred to simply as a vehicle and is preferably in the form of a passenger car, has, in its completed state, the holding arrangement and thus the instrument panel and the support. The motor vehicle has an interior, also referred to as a passenger compartment or passenger cabin, which is formed by a construction, in the form, for example, of a self-supporting body, of the motor vehicle. In this case, the holding arrangement and thus the instrument panel and the support are arranged in the interior. In the holding arrangement, the instrument panel, which is formed separately from the support, is held on the support. For example, the body has two vehicle pillars, referred to as body pillars or also referred to as structural pillars, which are in the form, for example, of A-pillars. The vehicle pillars are spaced apart from one another in the vehicle transverse direction of the motor vehicle, and in this case arranged on mutually opposite sides of the motor vehicle in the vehicle transverse direction. In this case, provision is made, for example, for the support to be attached to the vehicle pillars and to extend in the vehicle transverse direction of the motor vehicle, in particular continuously, from one of the vehicle pillars to the other vehicle pillar.

In order for it now to be possible to realize particularly advantageous behavior in the event of an accident, the invention provides that the holding arrangement has at least or exactly one load distribution element, which is arranged between at least or exactly one first subregion of the instrument panel and at least or exactly one second subregion of the support and is deformable in the event of an accident-related force application. The accident-related force application acts, for example, on the instrument panel and, via the latter, on the load distribution element, and results in deformation of the load distribution element. The accident-related deformation of the load distribution element is, for example, elastic deformation. The main objective and main purpose of the load distribution element are, in particular, to introduce accident-related loads into noncritical regions. The accident-related force application results, for example, from an impact of an object against the instrument panel, wherein this impact occurs, for example, when the motor vehicle is involved in an accident or during an accident test to which the motor vehicle is subjected. Furthermore, the accident-related force application can result, for example, from an impact of a head of an occupant of the interior against the instrument panel. The accident-related force application is or comprises, for example, a force, also referred to as an impact force which, in particular when the force application results from the fact that a head of an occupant of the interior strikes the instrument panel, is also referred to as a head impact force. Since it is deformable by the abovementioned accident-related force application, the load distribution element ensures an advantageous distribution, also referred to as load distribution, of a load that results from the accident-related load application and acts on the instrument panel, such that undesired direct load paths within the instrument panel, in particular within the holding arrangement as a whole, can be avoided. As a result, it is possible, for example, for excessive load on a person striking the instrument panel as a result of an accident to be avoided. In particular when the accident-related force application results from an impact of a head of a person located in the interior, pointwise action of force on the instrument panel and thus pointwise introduction of force into the instrument panel occurs. This pointwise introduction of force can be absorbed by means of the load distribution element and be distributed for example over an advantageously large area or introduced and transferred for example into an advantageously large region, such that excessively large pointwise loads and undesired direct load paths within the instrument panel can be avoided. In particular, the load distribution element, which is in the form, for example, of a load distribution plate, can ensure advantageous dissipation of the abovementioned force or load into at least one or more defined regions of the instrument panel and/or of the support, also referred to as a supporting structure, such that direct force paths and excessively large pointwise loads can be avoided.

In order for it to be possible, by means of the load distribution element, to realize a particularly advantageous load distribution and thus particularly advantageous behavior in the event of an accident, one embodiment of the invention provides that the load distribution element is made from a plastic foam, i.e. is made from a foamed plastic.

In this case, it has been found to be particularly advantageous when the plastic foam is made from expanded polypropylene (EPP). It has been found that not only does expanded polypropylene have sufficiently high rigidity to form advantageous load paths but expanded foam also has advantageous resilience such that, by means of the expanded polypropylene, a particularly advantageous load distribution can be ensured.

A further, particularly advantageous embodiment of the invention provides that the load distribution element is fastened to the support independently of the instrument panel. This should be understood as meaning that the load distribution element is not fastened to the support by means of the instrument panel, or not only by means of the instrument panel, such that, for example during disassembly and removal of the instrument panel from the carrier, the load distribution element remains or could remain fastened to the support without the instrument panel. As a result, in particular during production of the motor vehicle, advantageous and precise positioning of the load distribution element can be realized, and a particularly advantageously firm attachment of the load distribution element to the support can be ensured. As a result, particularly good behavior in the event of an accident can be ensured.

It has been found to be particularly advantageous when the load distribution element is screwed onto the support and as a result is fastened to the support, in particular independently of the instrument panel. As a result, an advantageously firm attachment of the load distribution element to the support can be realized, such that particularly advantageous load paths can be realized. As a result, particularly advantageous behavior in the event of an accident can be ensured.

In order for it to be possible to realize particularly advantageous behavior of the holding arrangement and thus of the motor vehicle as a whole in the event of an accident, a further refinement of the invention provides that the support is in the form of a hybrid component and, to this end, has a first support made from a metal material, for example from a steel or a magnesium alloy, and a second support part which is made from a plastic and is connected, in particular directly, to the first support part. In this case, provision is made in particular for the second support part, when the holding arrangement is in its installed position, to adjoin the first support part in the vehicle transverse direction of the motor vehicle, also referred to simply as a vehicle, in particular such that the second support part, when the holding arrangement is in its installed position, adjoins the first support part in the vehicle toward a passenger side of the motor vehicle in the vehicle transverse direction of the motor vehicle, and in particular is arranged on the passenger side. The holding arrangement takes up its installed position in the completed state of the motor vehicle having the holding arrangement. For example, a box of a glove compartment is integrated into the second support part, wherein the box, in particular an internal peripheral lateral surface of the box, delimits, in particular directly, a storage space of the glove compartment. In the completed state of the holding arrangement, in particular of the motor vehicle, a corresponding cover of the glove compartment is, for example, held movably, in particular pivotably, on the box, the cover being, for example, movable, in particular pivotable, relative to the box between a closed position and at least one open position. The storage space has at least or exactly one opening, via which the storage space, considered separately, opens out at or into the interior in the completed state of the motor vehicle. In this case, in the closed position, the opening is closed at least partially, in particular at least predominantly or entirely, by the cover, and in the open position, the cover at least partially opens up the opening.

In order for it to be possible to realize particularly advantageous behavior in the event of an accident, a further refinement of the invention provides that the second subregion of the support is formed by the plastic, and is thus formed by the second support part made from the plastic.

Since the load distribution element is arranged between the subregions, the second subregion is covered and thus overlapped by the load distribution element toward the first subregion. In this case, provision is made in particular for the second subregion, when the holding arrangement is in its installed position, to be covered and thus overlapped toward the interior by the load distribution element, with the result that particularly good behavior in the event of an accident can be ensured.

Finally, to realize particularly good behavior in the event of an accident, it has been found to be particularly advantageous for the second subregion, when the holding arrangement is in its installed position, to face upward in the vehicle vertical direction and/or toward the rear in the vehicle longitudinal direction. Thus, for example, a first part of the second subregion, when the holding arrangement is in its installed position, faces upward in the vehicle vertical direction. Alternatively or additionally, for example a second part of the second subregion, when the holding arrangement is in its installed position, faces toward the rear in the vehicle longitudinal direction. As a result, it is possible, for example, in the event of an accident, for example a frontal collision, for a body part that strikes the instrument panel during the accident, for example a head of a person located in the interior, to be advantageously cushioned via the instrument panel by the load distribution element. The load distribution element can ensure an advantageous load distribution such that excessive loading of the body part can be avoided.

A second aspect of the invention relates to a motor vehicle, also referred to as a vehicle and preferably in the form of a passenger car, which has a holding arrangement according to the first aspect of the invention. Advantages and advantageous refinements of the first aspect of the invention should be considered to be advantages and advantageous refinements of the second aspect of the invention, and vice versa.

In order for it to be possible to realize particularly advantageous behavior of the motor vehicle in the event of an accident, the second aspect of the invention provides that the load distribution element is arranged on a passenger side of the motor vehicle, in particular as seen in the vehicle transverse direction of the motor vehicle.

Further details of the invention will become apparent from the following description of a preferred exemplary embodiment with the associated drawing.

### BRIEF DESCRIPTION OF THE DRAWING

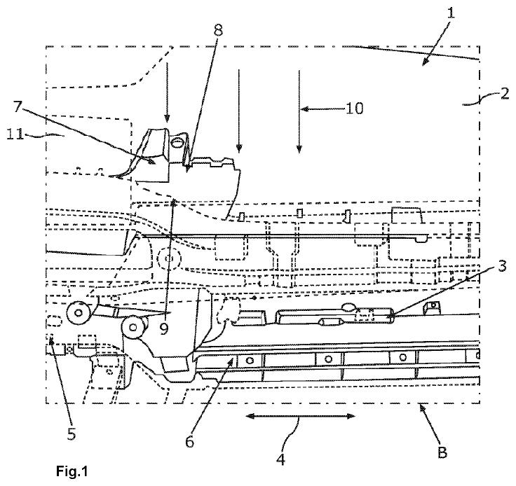

The single figure, FIG. 1, shows a detail of a schematic perspective view of a holding arrangement for holding an instrument panel on a support for a cockpit of a motor vehicle.

### DETAILED DESCRIPTION OF THE DRAWING

FIG. 1 shows a detail of a schematic perspective view of a holding arrangement 1 for holding an instrument panel 2, illustrated in a partially transparent manner in FIG. 1, on a support 3, also referred to as a support structure, base support or equipment support, for a cockpit of a motor vehicle, the interior of which, also referred to as a passenger compartment or passenger cabin, is formed by a construction, in the form, for example, of a self-supporting body, of the motor vehicle. In the completed state of the motor vehicle, also referred to as a vehicle, having the holding arrangement 1 and thus the instrument panel 2 and the support 3, the holding arrangement 1 and thus the instrument panel 2 and the support 3 are arranged in the interior. In particular, the structure has two vehicle pillars in the form of A-pillars, which are spaced apart from one another in the vehicle transverse direction of the motor vehicle. The vehicle transverse direction is indicated by a double arrow 4 in FIG. 1. It is apparent that FIG. 1 shows the holding arrangement 1 as seen by a passenger located in the interior, the direction of view of whom is directed forward, i.e. from the rear to the front, in the vehicle longitudinal direction of the motor vehicle.

In the holding arrangement 1, the instrument panel 2 is formed separately from the support 3 and held, in particular directly, on the support 3, such that at least one trim region of the support 3 is covered and thus clad by the instrument panel 2 toward the interior. Thus, persons, also referred to as occupants, located in the interior cannot visually perceive the trim region.

In the exemplary embodiment shown in FIG. 1, the support 3 is in the form of a hybrid component. In this case, the support 3 has a first support part 5, which is made from a metal material. The metal material is, for example, a steel or magnesium alloy. Furthermore, the support 3 has a second support part 6, which is made from a plastic. It is apparent from FIG. 1 that the support part 6, when the holding arrangement 1 is in its installed position, adjoins the support part 5 in the vehicle transverse direction of the motor vehicle and toward the passenger side, in the present case such that the support part 6 is arranged on the passenger side. The holding arrangement 1 and thus the instrument panel 2 and the support 3 take up their respective installed positions in the completed state of the motor vehicle having the holding arrangement 1. The support parts 5 and 6 are in this case connected directly together and form the support 3, for example such that the support part 6 made of the plastic is injection-molded onto the metal support part 5.

In order now for it to be possible to realize particularly advantageous behavior of the motor vehicle in the event of an accident, the holding arrangement 1 has at least or exactly one load distribution element 7, which is arranged between at least or exactly one first subregion 8 of the instrument panel 2 and at least or exactly one second subregion 9 of the support 3, in particular of the support part 6, such that the subregion 9 is covered by the load distribution element 7 toward the interior. The load distribution element 7 is in this case arranged in the trim region and thus not visually perceivable by persons located in the interior. Thus, the load distribution element 7 is entirely covered and thus overlapped by the instrument panel 2 toward the interior.

In the exemplary embodiment shown in FIG. 1, the load distribution element 7 is in the form of a cushion, which is also referred to as a pad, load distribution pad or load distribution cushion. The load distribution element 7 is deformable in the event of an accident-related force application on the holding arrangement 1, and, as a result, converts impact energy into deformation energy, with the result that excessive loading of an object or body part of a person that brings about the accident-related force application and, as a result of the accident, strikes the instrument panel 2, in particular the subregion 8, can be avoided.

In FIG. 1, arrows 10 indicate a pointwise force action on the instrument panel 2 and thus a resultant pointwise introduction of force into the instrument panel 2, wherein, for example, the pointwise introduction of force is the accident-related force application or results from the accident-related force application. The introduction of force indicated by the arrows 10 is pointwise in particular since or when the abovementioned body part striking the instrument panel 2, in particular the subregion 8, as a result of the accident is a head of a person located in the interior. A load resulting from the force action and the introduction of force can be absorbed by means of the load distribution element 7, particularly advantageously distributed and thus transmitted, in particular particularly extensively, to the support 3, such that excessively large pointwise loading and direct force paths within the holding arrangement 1 can be avoided.

For example, the load distribution element 7 is in the form of a load distribution plate.

In order for it to be possible to realize particularly advantageous load distribution by means of the load distribution element 7, the exemplary embodiment shown in FIG. 1 provides that the load distribution element is made from a plastic foam and is thus in the form of a plastic cushion or plastic pad. The plastic foam is a foamed plastic, wherein the plastic foam is preferably expanded polypropylene (EPP).

It is apparent from FIG. 1 that the second subregion 9 is a subregion of the second support part 6 and is thus formed by the support part 6. In this case, at least one part, in particular an at least predominant part, of the load distribution element 7 is arranged on the passenger side, wherein it is contemplated for the entire load distribution element 7 to be arranged on the passenger side.

For example, a box, illustrated in principle in FIG. 1, of a glove compartment is integrated into a region, denoted B in FIG. 1, of the support 3, in particular of the support part 6, wherein the box, in particular at the inner peripheral lateral surface of the box, delimits, in particular directly, a storage space. The storage space of the glove compartment has at least or exactly one opening, via which the storage compartment, considered separately, opens into the interior. In this case, the glove compartment has a cover which is held movably, in particular pivotably, on the box and which is movable, in particular pivotable, between a closed position and its open position relative to the box. It is apparent that, when the holding arrangement 1 is in its installed position, at least a part of the load distribution element 7 adjoins the box, and thus the glove compartment, upwardly in the vehicle vertical direction, in particular such that, when the holding arrangement 1 is in its installed position, the box is overlapped upwardly at least partially by the load distribution element 7 in the vehicle vertical direction of the motor vehicle.

Also apparent partially in FIG. 1 is a display 11, also referred to as a screen, of the motor vehicle, wherein the load distribution element 7 adjoins the electronic display 11 at least partially, in particular at least predominantly and thus at least by more than half or completely, in the vehicle transverse direction of the motor vehicle and in this case toward the passenger side. The subregion 9 overlapped toward the interior by the load distribution element 7 faces, for example, upwardly in the vehicle vertical direction of the motor vehicle and/or toward the rear in the vehicle longitudinal direction of the motor vehicle, with the result that particularly advantageous behavior in the event of an accident can be ensured. Preferably, the load distribution element 7 is fastened to the support 3 independently of the instrument panel 2, such that the load distribution element 7 is not fastened to the support 3 by means of the instrument panel 2, or not only by means of the instrument panel. For example, the load distribution element 7 is screwed onto the support 3 and, as a result, fastened to the support 3, in particular independently of the instrument panel 2.

### LIST OF REFERENCE SIGNS

1 Holding arrangement
2 Instrument panel
3 Support
4 Double arrow
5 First support part
6 Second support part
7 Load distribution element
8 First subregion
9 Second subregion
10 Arrows
11 Electronic display
B Region

1.-10. (canceled)

11. A holding arrangement for holding an instrument panel of a motor vehicle, comprising:
a support for a cockpit of the motor vehicle, on which the instrument panel, which is formed separately from the support, is held on the support; and
a load distribution element that is deformable in an event of an accident-related force application, the load distribution element being arranged between at least one first subregion of the instrument panel and at least one second subregion of the support.

12. The holding arrangement according to claim 11, wherein
the load distribution element is made from a plastic foam.

13. The holding arrangement according to claim 12, wherein
the plastic foam is made from expanded polypropylene.

14. The holding arrangement according to claim 11, wherein
the load distribution element is fastened to the support independently of the instrument panel.

15. The holding arrangement according to claim 11, wherein
the load distribution element is screwed onto the support and, as a result, is fastened to the support.

16. The holding arrangement according to claim 11, wherein
the support is in the form of a hybrid component comprising a first support part made from a metal material and a second support part made from a plastic and connected to the first support part.

17. The holding arrangement according to claim 16, wherein
the second subregion is formed by the plastic.

18. The holding arrangement according to claim 11, wherein
the second subregion, when the holding arrangement is in an installed position in the motor vehicle, faces upward in a vehicle vertical direction and/or toward a rear in a vehicle longitudinal direction.

19. A motor vehicle comprising a holding arrangement according to claim 11.

20. The motor vehicle according to claim 19, wherein
the load distribution element is arranged at least partially on a passenger side of the motor vehicle.
